(19) United States
(12) Patent Application Publication
(10) Pub. No.: US 2026/0150796 A1
(43) Pub. Date: Jun. 4, 2026

(54) REUSABLE CAPSULE FOR STREET TREE IRRIGATION

(71) Applicant: KING FAISAL UNIVERSITY, AL-AHSA (SA)

(72) Inventor: ABDELRAHIM FATHY ISMAIL, AL-AHSA (SA)

(21) Appl. No.: 18/969,245

(22) Filed: Dec. 4, 2024

(51) Int. Cl. A01G 27/02; A01G 27/00

(52) U.S. Cl. CPC A01G 27/02; A01G 27/003; A01G 27/008

(57) ABSTRACT

An irrigation capsule includes a capsule body made of rubber. A balloon is located within the capsule that compresses and expands depending on the fluid level within the capsule body. An air coil valve is located at the bottom of the capsule body and is connected to the ballon allowing the ballon to be filled with air. A capsule nozzle is located at the top of the capsule body and is used to refill the capsule body with fluid and adjust drip rate. A control lever is in communication with the capsule nozzle allowing for adjustment of drip rate from the capsule nozzle. The control lever has a reel that when rotated in a first direction compresses the capsule nozzle slowing the drip rate and when rotated in a second direction allows the capsule nozzle to expand increasing the drip rate.

### FIELD

The present disclosure relates to a device used for drip irrigation of trees that are dispersed and spaced out along streets.

### BACKGROUND

Irrigation of trees can sometimes be challenging. Trees that are dispersed and spaced out in streets typically require an extensive network of long hoses for traditional drip irrigation methods. For instance, if there are 20 trees spread along a 2-kilometer street, it will likely be necessary to deploy a hose network spanning 2 kilometers to permit appropriate drip irrigation specifically for these 20 trees. The expenses increase if these trees are not aligned in a single row, compelling alteration of the hose network course to reach the trees located at the outskirts. Accordingly, the presently known devices and systems for providing drip irrigation are overly expensive and need improvement.

### SUMMARY

Refillable irrigation capsules provide water to widely spaced trees without the need to deploy a network of hoses above the ground. Suitable refillable irrigation capsules in this regard can be made up of a suitable material such as, by way of non-limiting example, rubber, plastic, or leather. In certain embodiments, these capsules can have a capacity of 10 liters, or about 10 liters, depending on the need and the size of the plant to be irrigated. A suitable balloon, such as a pressure balloon, can be placed inside the bottom of the capsule, where the air is compressed down when the capsule is filled with water and expands upward when an upper capsule nozzle is opened, thereby beginning the drip irrigation process. The upper end of the capsule can have a hole with a diameter that can be adjusted to facilitate a slow drip of the water due to the air pressure at the bottom of the capsule. One or more capsules can be placed on the ground next to the tree trunk(s) to be irrigated to provide slow watering over a period of one day, one week, or more than one week. Smaller capsules can be used to water small plants and ornamental plants in homes or companies via drip irrigation when traveling or constantly busy.

An irrigation capsule in one embodiment includes a capsule body; a balloon located within the capsule body that compresses and expands depending on a fluid level within the capsule body; an air coil valve located at a bottom of the capsule body and connected to the ballon allowing the ballon to be filled with air; a capsule nozzle located at a top of the capsule body used to refill the capsule body with fluid and adjust fluid drip rate; and a control lever in communication with the capsule nozzle allowing for adjustment of the fluid drip rate from the capsule nozzle.

In certain embodiments, the control lever can include a reel that, when rotated in a first direction, compresses the capsule nozzle and, when rotated in a second direction, allows the capsule nozzle to expand.

In further embodiments, the ballon can occupy about ⅓ of the volume of the capsule body.

In other embodiments, the capsule body can have a volume of 10 liters, or about 10 liters. Further, the capsule body can be made of rubber in some embodiments.

In another embodiment, the present subject matter relates to a method of irrigating a plant using an irrigation capsule, the method comprising filling a capsule body with water; inflating a ballon located within the capsule body through an air coil located at a bottom of the capsule body; adjusting a water drip rate from a capsule nozzle located at a top of the capsule body using a control lever in communication with the capsule nozzle; and providing irrigation to a nearby plant.

In certain embodiments, the drip rate can be adjusted, at least in part, by rotating a reel of the control lever in a first direction, thereby pressing down on the capsule nozzle and decreasing the water drip rate.

In other embodiments, the drip rate can be adjusted, at least in part, by rotating a reel of the control lever in a second direction, thereby allowing the capsule nozzle to expand to increase the water drip rate.

In some embodiments, the ballon can be inflated to a pressure ranging from 20 psi to 25 psi, or about 20 psi to about 25 psi.

These and other features of the present disclosure will become readily apparent upon further review of the following specification.

### BRIEF DESCRIPTION OF DRAWINGS

FIG. 1 is an illustration of a water capsule.

FIG. 2A and FIG. 2B are illustrations of a reel and drip control lever.

Similar reference characters denote corresponding features consistently throughout the attached drawings.

### DETAILED DESCRIPTION

The following definitions are provided for the purpose of understanding the present subject matter and for construing the appended patent claims.

### Definitions

Throughout the application, where products are described as having, including, or comprising specific components, or where processes are described as having, including, or comprising specific process steps, it is contemplated that products of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

Refillable water capsules as described herein can use a drip irrigation system to water widely spaced trees without the need to deploy a network of hoses above the ground. The irrigation capsule can serve as a cost-effective alternative to traditional methods, thereby avoiding the expense of extending hose networks for distant plants.

In an embodiment, the operation of the capsule begins by filling it with water, which compresses an internal balloon due to the weight of the water. When the capsule's nozzle is opened by rotating a reel to expand it, the balloon pushes the water upward, causing water to drip slowly from the nozzle. The drip rate can be adjusted according to the size of the capsule opening; the larger the opening, the higher the drip rate, and vice versa, allowing for the customization of water flow based on the plant's needs.

In one embodiment, the air pressure in the internal balloon is within the range of about 20 to about 25 psi to pressurize the water upwards toward the drip nozzle. The balloon can represent up to one-third, or up to about one-third, of the capsule's volume while the remaining about two thirds is occupied by water. There is an air valve at the bottom of the capsule to add air to the inner balloon whenever needed. The capsule can be made of materials such as, but not limited to, rubber, plastic, or leather, and can have a capacity of about 10 liters, depending on the need and the size of the plant. The foregoing are examples. There are variations in the parameters used depending on the need, in use.

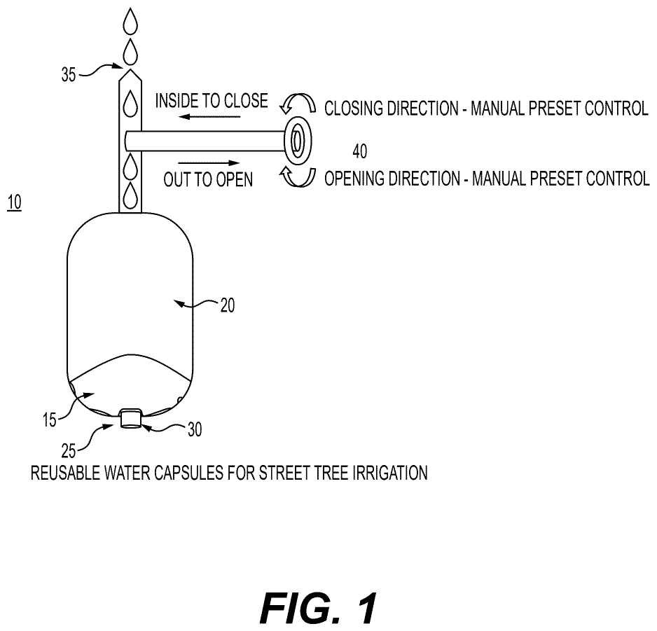

FIG. 1 is an illustration of a water capsule 10 having a body made of, for example, rubber, plastic, or leather. An air balloon 15 inside the capsule body 20 compresses and expands depending on the water level inside the capsule body 20. A hole 25 in the bottom of the capsule 10 has an air coil (valve) 30 inserted therein to fill the balloon 15 with air when needed. A capsule nozzle 35 is fitted with a reel and drip control lever 40 at the top of the capsule 10. The capsule nozzle 35 is used to refill the capsule 10 with water and adjust the water drip rate during irrigation. These adjustable drip rate capsules are essential for efficient plant watering during travel or busy schedules, offering a cost-effective alternative to lengthy hose networks.

The irrigation capsules as described herein are not only refillable but can also be customized in various sizes to suit specific requirements.

The functioning of the reel and drip control lever 40 is based on opening or closing the lever to regulate the amount and speed of water dripping from the nozzle 35 of the capsule 10. When rapid dripping is desired (based on the type of plant and the expected duration for the capsule to discharge its contents), the reel is manually rotated in the direction of opening. This allows for a faster water release.

On the other hand, if a reduced drip rate is required (for instance, when going on a long trip or if the plant does not need much water), the reel is manually rotated inward to partially close the nozzle. This creates a narrower opening, limiting the flow of water to a slower rate.

The reel is set once, at the time the water capsule is placed beside the tree or plant. After setting it, the capsule releases water at the desired rate until it is replaced. Every time a new, filled capsule is inserted, the reel can be adjusted again to determine the appropriate drip rate and speed, ensuring the plant receives the optimal amount of water according to its needs.

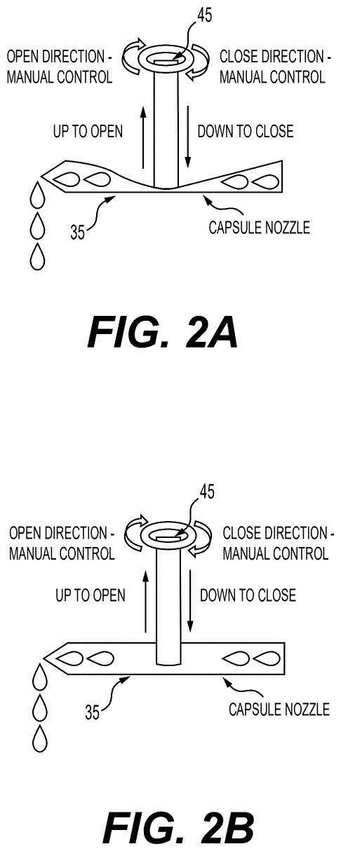

The reel and drip control lever 40 illustrated in FIG. 2A and FIG. 2B functions as a precise mechanism for adjusting the water flow rate and drip frequency according to the plant's needs or the desired time interval before refilling the capsule. The control lever 40 includes a rotatable reel 45 that allows the upper opening of the capsule to be expanded or narrowed, directly affecting the water flow rate.

The reel 45 can be manually rotated in the desired direction to achieve the needed adjustment:
1. Expansion increases the water flow rate, allowing faster dripping suited for plants with higher water requirements (See FIG. 2B).
2. Narrowing decreases the water flow rate, enabling a slower drip over extended periods (such as a week), ideal for plants with lower water needs or prolonged irrigation schedules (See FIG. 2A).

The reel and drip control lever 40 serves as the primary mechanism for regulating the rate at which water drips over a set period (for instance, one week). When the water-filled capsule is placed beside a tree, the lever manages the gradual release of water by internal balloon pressure. The water output is adjusted by expanding or narrowing the lever, which can be controlled by rotating the reel 45 in either direction (widening or tightening). This process allows for a variable drip rate-fast or slow-depending on the desired interval for refilling the capsule or the specific water needs of the plant (whether it requires minimal or substantial water). The lever is manually operated to adjust the reel 45 to the needed level, each time the water-filled capsule is positioned next to the plant.

This manual mechanism allows the user to flexibly adjust the drip rate based on the plant's needs at that particular time, making the capsule a customizable and water-efficient solution.

When the capsule's nozzle 35 is opened by rotating the reel 45 to expand it, the air balloon compresses the water, directing it upwards to drip according to need (depending on how wide or narrow the capsule's opening is).

The following is a description of how the capsule works step by step:

Filling with Water: The capsule is filled with water, which compresses the internal balloon due to the weight of the water.

Pressure Inside the Capsule: The weight of the water causes air inside the balloon to compress, increasing the internal pressure.

Opening the Nozzle: When watering is needed, the capsule's nozzle is opened by rotating the reel to expand it. This creates a pathway for the water to flow.

Pushing Water Upwards: Due to the pressure generated by the compressed air, the balloon pushes the water upwards toward the drip nozzle.

Dripping: Water begins to drip slowly from the nozzle. The drip rate is controlled based on the size of the capsule opening; the larger the opening, the higher the drip rate, allowing for customization of water flow according to the plant's needs.

Continuous Irrigation: The capsule can operate for extended periods, providing continuous watering for plants without the need for frequent monitoring, making it convenient for use during travel or periods of care absence.

It is to be understood that the reusable capsule for street tree irrigation is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An irrigation capsule comprising:
a capsule body;
a balloon located within the capsule body that compresses and expands depending on a fluid level within the capsule body;
an air coil valve located at a bottom of the capsule body and connected to the balloon allowing the balloon to be filled with air;
a capsule nozzle located at a top of the capsule body used to refill the capsule body with fluid and adjust a fluid drip rate; and
a control lever in communication with the capsule nozzle, wherein the control lever comprises a reel that, when rotated in a first direction, compresses the capsule nozzle and, when rotated in a second direction, allows the capsule nozzle to expand, thereby allowing for adjustment of the fluid drip rate from the capsule nozzle.

2. (canceled)

3. The irrigation capsule as recited in claim 1, wherein the balloon occupies ⅓ of the capsule body's volume.

4. The irrigation capsule as recited in claim 1, wherein the capsule body has a volume of 10 liters.

5. The irrigation capsule as recited in claim 1, wherein the capsule body is made of rubber.

6. The irrigation capsule as recited in claim 1, wherein the fluid is water.

7. An irrigation capsule comprising:
a capsule body made of rubber and having a volume of about 10 liters;
a balloon located within the capsule body that compresses and expands depending on a fluid level within the capsule body;
an air coil valve located at a bottom of the capsule body and connected to the ballon balloon allowing the balloon to be filled with air;
a capsule nozzle located at a top of the capsule body used to refill the capsule body and adjust a fluid drip rate; and
a control lever in communication with the capsule nozzle, wherein the control lever comprises a reel that, when rotated in a first direction, compresses the capsule nozzle and, when rotated in a second direction, allows the capsule nozzle to expand, thereby allowing for adjustment of the fluid drip rate from the capsule nozzle.

8. (canceled)

9. The irrigation capsule as recited in claim 7, wherein the balloon occupies ⅓ of the volume of the capsule body.

10. The irrigation capsule as recited in claim 7, wherein the fluid is water.

11. A method of irrigating a plant using an irrigation capsule comprising:
filling a capsule body with water;
inflating a balloon located within the capsule body through an air coil located at a bottom of the capsule body;
adjusting a water drip rate from a capsule nozzle located at a top of the capsule body using a control lever in communication with the capsule nozzle, wherein adjusting the water drip rate comprises rotating a reel of the control lever in a first direction, thereby pressing down on the capsule nozzle and decreasing the water drip rate; and
providing irrigation to a nearby plant.

12. (canceled)

13. The method as recited in claim 11, wherein adjusting the water drip rate comprises rotating a reel of the control lever in a second direction, thereby allowing the capsule nozzle to expand to increase the water drip rate.

14. The method as recited in claim 11, wherein the balloon is inflated to a pressure ranging from about 20 psi to about 25 psi.
